(19) United States
(12) Patent Application Publication
(10) Pub. No.: US 2026/0275208 A1
(43) Pub. Date: Sep. 17, 2026

(54) PLANT AND PROCESS FOR PRODUCING RENEWABLE HYDROCARBONS WITH REDUCED CO2-FOOTPRINT AND IMPROVED HYDROGEN INTEGRATION

(71) Applicant: TOPSOE A/S, Kgs. Lyngby (DK)

(72) Inventors: Nitesh BANSAL, Kgs. Lyngby (DK); Adam Samir KADHIM, Kgs. Lyngby (DK); Yassir I. Z. GHIYATI, Kgs. Lyngby (DK)

(73) Assignee: TOPSOE A/S, Kgs. Lyngby (DK)

(21) Appl. No.: 19/469,046

(22) PCT Filed: Apr. 4, 2024
(86) PCT No.: PCT/EP2024/059177

§ 371 Date: Sep. 25, 2025

(30) Foreign Application Priority Data
Apr. 5, 2023 (IN) 202311025750
Jun. 20, 2023 (DK) PA202330089

(51) Int. Cl. C10G 65/04; C01B 3/38

(52) U.S. Cl. CPC C10G 65/04; C01B 3/38; C01B 2203/0233; C01B 2203/0283; C01B 2203/0405; C01B 2203/0475; C01B 2203/062; C01B 2203/86; C10G 2300/207; C10G 2300/4081

(57) ABSTRACT

A process and plant for producing a hydrocarbon product. The plant comprises a hy-droprocessing stage and downstream separation stage for producing a hydrocarbon product and an off-gas comprising hydrocarbons. A hydrogen producing unit (HPU) is arranged to receive said off-gas. The HPU comprises a pre-reforming unit and an electrically heated steam methane reformer (e-SMR), a shift section, a hydrogen purifica-tion section, as well as a CO₂-removal unit, and produces make-up hydrogen gas for the hydroprocessing stage, as well as waste off-gas which is supplied as hydrocarbon feed to the e-SMR, and as fuel to fired heaters of e.g. said hydroprocessing stage.

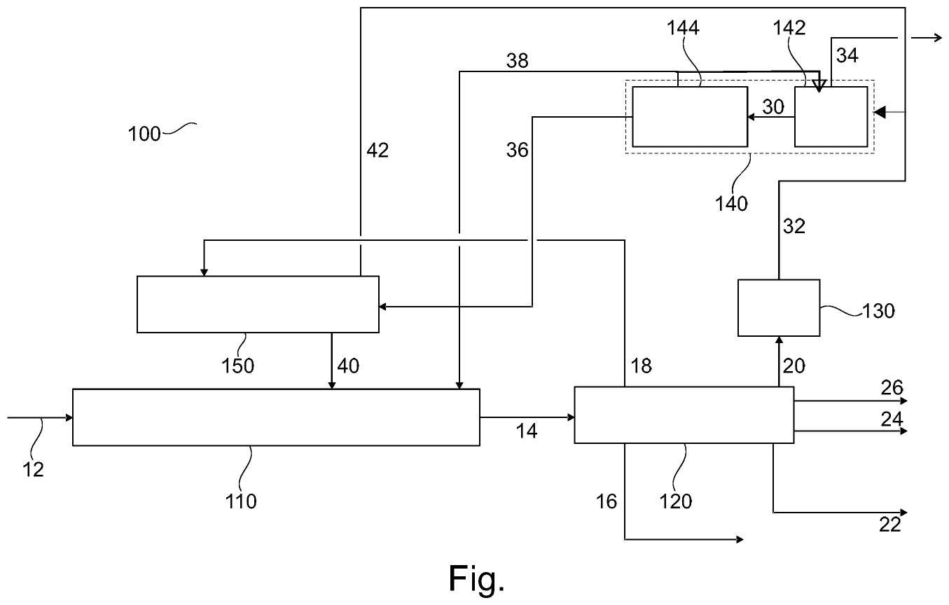

### TECHNICAL FIELD

The present invention relates to a hydrotreatment process and plant for producing a hydrocarbon product boiling in transportation fuel range, in particular any of the diesel fuel boiling range, jet fuel boiling range such as sustainable aviation fuel (SAF) and naphtha boiling range, by the hydroprocessing of a feedstock originating from a raw material of renewable origin, and which process and plant is integrated with a hydrogen producing unit (HPU).

### BACKGROUND

Following today's demand and competitiveness in hydrogen production, significant efforts have been put into developing optimized production for hydrogen plants, with the objective to improve overall energy efficiency and reduce capital cost. The need for more cost-efficient hydrogen production has spurred the development of technology and catalysts for large-scale hydrogen production units, in order to benefit from economy of scale.

WO2020221642A1 describes an ATR-based hydrogen process and plant. Similar technology is provided in EP 2103569 B1, U.S. Pat. Nos. 8,187,363, 9,028,794, US2018237297 and U.S. Pat. No. 8,715,617.

There is also a growing interest to produce diesel, jet fuel as sustainable aviation fuel (SAF) and naphtha from renewable feedstocks, i.e. from a raw material of renewable origin. Often a renewable feedstock contains high amount of oxygen compound and unsaturated hydrocarbon. During the hydrotreating of renewable feedstock, the oxygen is mainly removed as H₂O. This is called the hydrodeoxygenation (HDO) pathway. Oxygen can also be removed by dicarboxylic pathway, which generates CO₂ instead of H₂. For instance:

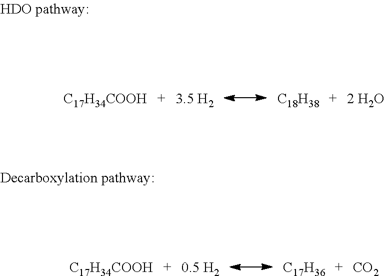

Some of the renewable feed also contain nitrogen. Removing nitrogen also requires hydrogen.

Overall, hydrotreating of renewable feedstock (feedstock rich in e.g. oxygenates including vegetable oils and others, such as pyrolysis oils) requires high amount of hydrogen gas consumption. To produce this high amount of hydrogen, requirement of hydrocarbon feed e.g. natural gas as feed and fuel is very high. This will also increase the CO₂ footprint.

Furthermore, fired heaters are normally utilized for heating hydrocarbon feed streams to the required hydrotreating temperatures, such as about 350° C. or higher. For hydrogen production, traditionally, fired steam methane reformer (SMR)-based hydrogen producing units are provided, and lately also autothermal reformer (ATR)-based hydrogen producing units, the latter normally also requiring a fired heater for heating the hydrocarbon feed to the ATR. A fired heater is a very large and cost intensive unit, requiring a considerable plot space and involving significant direct carbon emissions due to the flue gas generated therefrom by the burning of a fuel, typically natural gas. So, design and operation of a process and plant without a fired heater or minimal use thereof offers a significant reduction in capital and operating expenses and enables a drastic decrease in carbon emissions, thus significantly reducing the carbon footprint of the process and plant. For a SMR, traditionally the pre-heating of the hydrocarbon feed is carried out in the combustion side of the SMR, thereby also requiring a considerable plot space and involving significant direct carbon emissions due to the flue gas generated therefrom by the burning of fuel, typically also natural gas, in said combustion side.

Applicant's patent application IN 202111046772A discloses a SMR-based hydrogen plant with high CO₂ capture. CO₂ is captured from the flue gas produced in the SMR and from process gas, the latter being shifted synthesis gas or off-gas from a downstream hydrogen purification unit.

The term “SMR”, as is well-known in the art, means a fired steam methane reformer, which comprises a reaction side and a combustion side. For the purposes of the present application, the term is used interchangeably with the term “fired SMR” or “tubular reformer”. The term “ATR”, as is also well-known in the art, means autothermal reformer. Details are provided farther below in the application.

For the purposes of the present application, the term hydrogen producing unit (HPU) may be used interchangeably with the term “hydrogen plant”.

Applicant's patent application WO 2021180805 and WO 2022152896 discloses a process and plant for producing hydrocarbons with reduced CO₂-footprint and improved hydrogen integration. A hydrogen producing plant is provided, in which off-gas from a hydrogen purification unit such as pressure swing adsorption (PSA) unit, is supplied as fuel to burners of a reforming unit. The reforming unit is, in an embodiment, an electrically heated steam methane reformer (e-SMR).

It would be desirable to provide a process and plant for producing hydrocarbon products boiling in the transportation fuel range, including a HPU, having lower total CO₂ emissions and thus lower carbon intensity.

### SUMMARY

The present invention relates to a process for producing a hydrocarbon product as described in claims 1 and 2, and associated plant for producing such hydrocarbons as described in claim 10.

Further details of the process and plant and are provided in the following description text and associated FIGURE as well as the appended claims.

### DETAILED DESCRIPTION

In a general embodiment according to a first aspect of the invention, there is provided a process for producing a hydrocarbon product, said process comprising the steps of:
i) passing a feedstock originating from a renewable source through a hydroprocessing stage for producing a main hydrotrotreated stream;
ii) passing the main hydrotreated stream to a separation stage for producing:
   an aqueous stream,
   a hydrogen-rich stream as a first recycle gas stream,
   an off-gas stream comprising hydrocarbons,
   and said hydrocarbon product, boiling at above 50° C.;
iii) passing the first recycle gas stream to the hydroprocessing stage;
iv) passing the off-gas stream as a second recycle gas stream to a hydrogen producing unit (HPU) for producing a hydrogen stream as a make-up hydrogen stream;
v) passing at least a portion, such as the entire portion, of the make-up hydrogen stream to the hydroprocessing stage;
wherein said HPU comprises subjecting said second recycle gas stream, optionally together with one or more of said hydrocarbon product, preferably naphtha, to: catalytic steam reforming in a steam reforming unit for providing a synthesis gas; water gas shift conversion of said synthesis gas in a water gas shift unit for providing a shifted synthesis gas; carbon dioxide removal of at least a portion of said shifted synthesis gas, such as the entire shifted synthesis gas, in a CO₂-separation unit thereby providing a CO₂-rich gas stream and a CO₂-depleted synthesis gas stream; and hydrogen purification of at least a portion, such as the entire portion, of said CO₂-depleted synthesis gas stream, in a hydrogen purification unit; wherein the steam reforming unit is an electrically heated steam methane reformer (e-SMR) together with a pre-reforming unit arranged upstream said e-SMR; wherein said hydrogen purification unit produces said make-up hydrogen stream and a waste off-gas stream; and wherein at least a portion of said waste off-gas stream is supplied as hydrocarbon feed to a point between the pre-reforming unit and the e-SMR; and as fuel to a fired heater in any of: a catalytic hydrotreating unit of the hydroprocessing stage, a separation unit of the separation stage, optionally an auxiliary steam boiler for steam production, and combinations thereof.

In another general embodiment according to a first aspect of the invention, the CO₂-removal is provided in the waste off-gas of the hydrogen purification unit. Accordingly, there is provided a process for producing a hydrocarbon product, said process comprising the steps of:
i) passing a feedstock originating from a renewable source through a hydroprocessing stage for producing a main hydrotrotreated stream;
ii) passing the main hydrotreated stream to a separation stage for producing:
   an aqueous stream,
   a hydrogen-rich stream as a first recycle gas stream,
   an off-gas stream comprising hydrocarbons,
   and said hydrocarbon product, boiling at above 50° C.;
iii) passing the first recycle gas stream to the hydroprocessing stage;
iv) passing the off-gas stream as a second recycle gas stream to a hydrogen producing unit (HPU) for producing a hydrogen stream as a make-up hydrogen stream;
v) passing at least a portion, such as the entire portion, of the make-up hydrogen stream to the hydroprocessing stage;
wherein said HPU comprises subjecting said second recycle gas stream, optionally together with one or more of said hydrocarbon product, preferably naphtha, to: catalytic steam reforming in a steam reforming unit for providing a synthesis gas; water gas shift conversion of said synthesis gas in a water gas shift unit for providing a shifted synthesis gas; hydrogen purification of at least a portion of said shifted synthesis gas, such as the entire shifted synthesis gas, in a hydrogen purification unit; wherein the steam reforming unit is an electrically heated steam methane reformer (e-SMR) together with a pre-reforming unit arranged upstream said e-SMR; wherein said hydrogen purification unit produces said make-up hydrogen stream and a waste off-gas stream; wherein at least a portion, such as the entire portion, of said waste off-gas stream is subjected to: carbon dioxide removal in a CO₂-separation unit thereby providing a CO₂-rich gas stream and a CO₂-depleted waste off-gas stream; and wherein at least a portion of said CO₂-depleted waste off-gas stream and/or at least a portion of said waste off-gas stream is supplied as hydrocarbon feed to a point between the pre-reforming unit and the e-SMR; and as fuel to a fired heater in any of: a catalytic hydrotreating unit of the hydroprocessing stage, a separation unit of the separation stage, optionally an auxiliary steam boiler for steam production, and combinations thereof.

The provision of hydrogen needed in the hydroprocessing stage is thus mainly from said make-up hydrogen stream and said first recycle stream. The present invention provides a high level of integration of hydrogen streams and off-gas streams generated in the process and plant, hence there is no need to resort to the use of external makeup hydrogen, i.e. make-up hydrogen supplied from the outside. Said CO₂-depleted waste off-gas or said waste off-gas is supplied between the pre-reforming unit and the e-SMR. It has been found that the CO₂-depleted waste off-gas is rich in CH₄ and CO and thus particularly advantageous for directly feeding it as hydrocarbon feed to the e-SMR, hence downstream the pre-reforming unit; in other words, between the prereforming unit and the e-SMR. Feeding the CO₂-depleted waste off-gas or waste offgas stream farther upstream, for instance to the cleaning unit of the HPU, for instance to a hydrogenation and sulfur absorption unit therein, will induce a methanation reaction and thereby undesired exotherms in such unit(s). At the same time, a fired heater in e.g. the catalytic hydrotreating units of the hydroprocessing stage is fueled with e.g. the waste off-gas from the HPU from which CO₂ has been removed. The requirements for an external fuel source such as natural gas for the fired heater are significantly reduced.

The off-gas being fed as second recycle gas stream to the HPU comprises light hydrocarbons such as CH₄ thus minimizing or eliminating the need of externally sourced hydrocarbon feed, such as natural gas. More specifically, the second recycle gas stream entering the HPU contains light hydrocarbons such as C₁-C₄ hydrocarbons, H₂, NH₃, CO and CO₂; yet no H₂S or only minor amounts of H₂S particularly where an off-gas separation stage for removing H₂S is provided, as it will also become apparent from a below embodiment. The off-gas stream (second recycle stream) contains hydrogen not consumed from the hydrotreating unit(s) of the hydroprocessing stage as soluble hydrogen in hydrocarbon phase. Hydrocarbon consumption in HPU, such as consumption of externally sourced natural gas, is significantly reduced or eliminated and thereby the energy efficiency of the process and plant for producing hydrocarbons is significantly increased.

While traditionally, most the waste off-gas in the HPU is sent to e.g. the combustion side of an SMR of the HPU, or even burned off (flared), the e-SMR in the HPU of the present invention, contrary to e.g. an SMR, does not produce a flue gas, thereby also enabling to direct a portion of the waste off-gas or the entire CO₂-depleted waste offgas stream from the hydrogen purification unit of the HPU to fired heater(s) of i.a. of the hydroprocessing stage and separation stage of the process, optionally also auxiliary steam boiler(s) for steam production. Higher integration not only with respect with the make-up hydrogen stream from the HPU, but also the waste off-gas generated in the HPU, is thereby achieved.

It will be understood that the combustion side of an SMR comprises burners which traditionally at least in part utilize natural gas as hydrocarbon fuel. Flue gas comprising CO₂ is thus generated. It will be understood that another type of reforming unit, such as an autothermal reformer (ATR) typically has a fired heater associated thereto, which traditionally at least in part utilizes natural gas as hydrocarbon fuel. Flue gas comprising CO₂ is thus generated.

In an embodiment, said at least a portion of said waste off-gas stream, is directly supplied as hydrocarbon feed to a point between the pre-reforming unit and the e-SMR. In an embodiment, said at least a portion of said CO₂-depleted waste off-gas stream and/or at least a portion of said waste off-gas stream, is directly supplied as hydrocarbon feed to a point between the pre-reforming unit and the e-SMR.

The term “directly supplied” or “directly supplying” is used interchangeably with the term “directly passed” or “directly passing”, respectively, and means without passing through an intermediate unit changing the composition of the stream. The term is also used interchangeably with the term “directly sent” or “sent directly”.

Thereby, the provision of additional process units is obviated, thus reducing capital expenses (CAPEX) and operating expenses (OPEX) which will be associated by e.g. providing units changing the composition of this stream sent to between the prereforming unit and e-SMR, while at the same time in association with the provision of the e-SMR, maintaining the HPU as compact as possible. As the HPU is an integrated part of the hydroprocessing, the capability of providing a compact HPU in association with the hydroprocessing is highly advantageous.

The steam reforming unit is an electrically heated steam methane reformer (e-SMR), where electrical resistance is used for generating the heat for catalytic reforming. When using e-SMR, electricity from green resources may be utilized, such as from electricity produced by wind power, hydropower, and solar sources, optionally also from thermonuclear sources, thereby further minimizing the carbon dioxide footprint. For a description of e-SMR, reference is given to e.g. WO 2019/228797 A1. The provision of the e-SMR drastically reduces the carbon footprint of the HPU and thereby the process and plant for producing the hydrocarbons. Further, the e-SMR is notoriously compact so the plot size of the HPU is also drastically reduced as so are the associated capital expenses.

In a further general embodiment according to a first aspect of the invention, the HPU comprises reforming in a steam reforming unit producing a flue gas and CO₂-removal is also provided in said flue gas. Accordingly, there is also provided a process for producing a hydrocarbon product, said process comprising the steps of:
i) passing a feedstock originating from a renewable source through a hydroprocessing stage for producing a main hydrotrotreated stream;
ii) passing the main hydrotreated stream to a separation stage for producing:
   an aqueous stream,
   a hydrogen-rich stream as a first recycle gas stream,
   an off-gas stream comprising hydrocarbons,
   and said hydrocarbon product, boiling at above 50° C.;
iii) passing the first recycle gas stream to the hydroprocessing stage;
iv) passing the off-gas stream as a second recycle gas stream to a hydrogen producing unit (HPU) for producing a hydrogen stream as a make-up hydrogen stream;
v) passing the make-up hydrogen stream to the hydroprocessing stage;
wherein said HPU comprises feeding: said second recycle gas stream, optionally a hydrocarbon feedstock such as natural gas, optionally also together with one or more of said hydrocarbon product, preferably naphtha; the HPU further comprises subjecting said feed to: catalytic steam reforming in a steam reforming unit for providing a synthesis gas; water gas shift conversion of said synthesis gas in a water gas shift unit for providing a shifted synthesis gas; optionally, carbon dioxide removal of at least a portion of said shifted synthesis gas, such as the entire shifted synthesis gas, in a CO₂-separation unit thereby providing a CO₂-rich gas stream and a CO₂-depleted synthesis gas stream; optionally, hydrogen purification of at least a portion of said shifted synthesis gas or said CO₂-depleted synthesis gas stream, such as the entire shifted synthesis gas or the entire CO₂-depleted synthesis gas stream, in a hydrogen purification unit; wherein said optional hydrogen purification unit produces a hydrogen stream and a waste off-gas stream; optionally, wherein at least a portion, such as the entire portion, of said waste off-gas stream is subjected to: a carbon dioxide removal in a CO₂-separation unit thereby providing a CO₂-rich gas stream and a CO₂-depleted waste offgas stream; wherein said CO₂-depleted synthesis gas stream or said hydrogen stream, or a combination thereof, is withdrawn as said make-up gas hydrogen stream; wherein the steam reforming unit is any of: an electrically heated steam methane reformer (e-SMR); a convection reformer, a tubular reformer i.e. steam methane reformer (SMR), autothermal reformer (ATR), and combinations thereof; together with a pre-reforming unit arranged upstream said steam reforming unit; wherein the steam reforming unit produces a flue gas stream; wherein at least a portion, such as the entire portion, of said flue gas stream is subjected to carbon dioxide removal in a separate CO₂-separation unit thereby providing a separate CO₂-rich gas stream; and wherein at least a portion of any of said: CO₂-depleted synthesis gas stream, waste off-gas stream, and CO₂-depleted waste off-gas stream, is supplied, optionally directly supplied, as hydrocarbon feed to a point between the pre-reforming unit and the steam reforming unit; and as fuel to a fired heater in any of: a catalytic hydrotreating unit of the hydroprocessing stage, a separation unit of the separation stage, optionally, an auxiliary steam boiler for steam production, and combinations thereof.

In accordance with this further general embodiment, it would be understood that where there is CO₂-removal of the shifted syngas, there is no CO₂-removal in the waste offgas from the hydrogen purification unit; and where there is CO₂-removal of the waste off-gas from the hydrogen purification unit, there is no CO₂ removal of the shifted synthesis gas. Further, in either case there is CO₂-removal of flue gas produced in the steam reforming unit, for instance where the steam reforming unit comprises an SMR or a convection heated reformer. A combination of an e-SMR, which does not produce a flue gas, with a steam reforming unit producing a flue gas, is also envisaged in this further general embodiment. The CO₂-removal from the shifted synthesis gas or the waste off-gas from the hydrogen purification unit is also referred to as “pre-combustion CO₂ capture”. The CO₂-removal from the flue gas of a steam reforming unit is also referred to as “post-combustion CO₂ capture”.

The term “first aspect of the invention” means the process for producing a hydrocarbon product. The term “second aspect of the invention” means the plant, i.e. system, for producing a hydrocarbon product.

The term “present invention” or simply “invention” may be used interchangeably with the term “present application” or simply “application”.

The term “comprising” includes “comprising only”, i.e. “consisting of”.

The terms “hydrotreating” and “hydroprocessing” are used interchangeably. The hydroprocessing stage may comprise one or more catalytic hydrotreating units, for instance a first and second catalytic hydrotreating unit.

The term “unit” means “section” or “stage”. Thus, the terms “unit”, “section” and “stage” are used interchangeably. A unit, section, stage, may be understood in singular or plural form. For instance, a unit may comprise itself a number of units. For instance, the water gas shift unit may comprise several units, such as high and low temperature shift units.

More generally, the use of the indefinite article “a” or “an” means “at least one”. For instance, the term “an e-SMR” means at least one e-SMR. For instance, an e-SMR is a single e-SMR. The term “at least one” is interchangeably with the term “one or more”.

The term “and/or” means in connection with a given embodiment any of three options. The term “and/or” may be used interchangeably with the term “at least one of” the three options. The term “CO₂-rich gas stream” means a stream containing 95% vol, or more, for instance 99.5% of carbon dioxide.

The make-up hydrogen stream is suitably “hydrogen rich” meaning that the major portion of this stream is hydrogen; i.e. over 75%, such as over 85%, preferably over 90%, more preferably over 95%, even more preferably over 99% of this stream is hydrogen. In addition to hydrogen, the make-up hydrogen stream may for example comprise steam, nitrogen, argon, carbon monoxide, carbon dioxide, and/or hydrocarbons. The make-up hydrogen stream suitably comprises only low amounts of hydrocarbon, such as for example less than 5% hydrocarbons or less than 3% hydrocarbons or less than 1% hydrocarbons.

The term “suitably” means “optionally”, i.e. an optional embodiment.

Other definitions are provided in connection with one or more of below embodiments.

In said further general embodiment, the steam reforming unit is: convection reformer, preferably comprising one or more bayonet reforming tubes such as an HTCR reformer i.e. Topsøe bayonet reformer, where the heat for reforming is transferred by convection along with radiation; a tubular reformer i.e. conventional steam methane reformer or fired steam methane reformer (SMR) as mentioned above, where the heat for reforming is transferred chiefly by radiation; autothermal reformer (ATR) as mentioned above, where partial oxidation of the hydrocarbon feed with oxygen and steam followed by catalytic reforming. In a particular embodiment, an e-SMR may be arranged together with any of the above steam reforming units.

For more information on these reformers, details are herein provided by direct reference to Applicant's patents and/or literature. For instance, for tubular and autothermal reforming an overview is presented in “Tubular reforming and autothermal reforming of natural gas—an overview of available processes”, lb Dybkjær, Fuel Processing Technology 42 (1995) 85-107; and EP 0535505 for a description of HTCR. For a description of ATR and/or SMR for large scale hydrogen production, see e.g. the article “Largescale Hydrogen Production”, Jens R. Rostrup-Nielsen and Thomas Rostrup-Nielsen”: https://www.topsoe.com/sites/default/files/topsoe_large_scale_hydrogen_produc.pdf These technologies are well known in the art of hydrogen production.

In an embodiment, the catalyst in the steam reforming unit is a reforming catalyst, e.g. a nickel based catalyst. In an embodiment, the catalyst in the water gas shift reaction is any catalyst active for water gas shift reactions. The said two catalysts can be identical or different. Examples of reforming catalysts are Ni/MgAl₂O₄, Ni/Al₂O₃, Ni/CaAl₂O₄, Ru/MgAl₂O₄, Rh/MgAl₂O₄, Ir/MgAl₂O₄, Mo₂C, Wo₂C, CeO₂, Ni/ZrO₂, Ni/MgAl₂O₃, Ni/CaAl₂O₃, Ru/MgAl₂O₃, or Rh/MgAl₂O₃, a noble metal on an Al₂O₃ carrier, but other catalysts suitable for reforming are also conceivable. The catalytically active material may be Ni, Ru, Rh, Ir, or a combination thereof, while the ceramic coating may be Al₂O₃, ZrO₂, MgAl₂O₃, CaAl₂O₃, or a combination therefore and potentially mixed with oxides of Y, Ti, La, or Ce. The maximum temperature of the reactor may be between 850-1300° C. The pressure of the feed gas may be 15-180 bar, preferably about 25 bar. Steam reforming catalyst is also denoted steam methane reforming catalyst or methane reforming catalyst.

The pre-reforming is conducted in a pre-reforming unit, as is well-known in the art. In an embodiment, a single, i.e. one, pre-reforming unit is provided. Thereby also enabling low CAPEX and OPEX by maintaining the HPU as compact as possible. Pre-reforming is an additional reforming step, which allows a syngas with a desired composition to ultimately be obtained, i.e. in which higher hydrocarbons are converted to methane. Prereforming suitably takes place at ca. 350-700° C. to convert higher hydrocarbons as an initial step. Pre-reforming catalysts and reactors suitable for such processes are commercially available and known to the skilled person. Prereformer units (prereformers) used in the present invention are catalyst-containing reactor vessels, and are typically adiabatic. In the prereforming units, heavier hydrocarbon components in the hydrocarbon feedstock are steam reformed and the products of the heavier hydrocarbon reforming are methanated. The skilled person can construct and operate suitable prereformer units as required. Prereformer units suitable for use in the present system/process are provided in applicant's co-pending applications EP20201822 and EP21153815. The pre-reformed stream comprises methane, hydrogen, carbon monoxide and also carbon dioxide. The pre-reformed stream at the outlet of the prereformer may be in the temperature range 400° C.-500° C.

In an embodiment, the HPU comprises apart from feeding said second recycle gas stream, optionally together with said one or more of said hydrocarbon products, such as naphtha, feeding other light product produced in the process, and a hydrocarbon feedstock such as natural gas. Natural gas and optionally said naphtha, and the second recycle stream are preferably fed separately to the hydrogen producing unit. By including a part of the hydrocarbon product, in particular the renewable naphtha as part of the feed to the HPU, an even higher reduction in energy consumption is achieved. The feed to the hydrogen production unit may also include LPG (a C₃-C₄ gas mixture) as said other light product.

In an embodiment, the process further comprises: carbon capture and storage (CCS), or carbon capture and utilization (CCU), of said CO₂-rich gas stream.

The term “carbon capture and storage (CCS)” means a process in which the pure stream of carbon dioxide, i.e. said CO₂-rich gas stream, is separated, treated and transported to a storage location. Suitably, water is removed to provide a dry CO₂-rich gas stream which is then transported to the storage location. The term “carbon capture and utilization (CCU)” means that the CO₂-rich gas stream is used for producing high-value chemicals, such as a component of synthesis gas for the production of methanol i.e. as a methanol synthesis gas.

In an embodiment, the process further comprises: prior to said catalytic steam reforming, subjecting said second recycle stream to cleaning in a cleaning unit, said cleaning unit suitably being a sulfur-chlorine-metal absorption or catalytic unit. Hence, it will be understood that the cleaning unit is for removal of at least one of: sulfur and chlorine compounds. This technology is also well-known in the art of hydrogen production.

In an embodiment, prior to passing the make-up hydrogen stream to the hydroprocessing stage, the makeup hydrogen stream passes through a compressor section comprising a make-up compressor optionally also a recycle compressor, the make-up compressor also producing a hydrogen recycle stream which is added to the hydrogen producing unit, preferably directly to the second recycle stream entering the hydrogen producing unit, and/or to the cleaning unit of the hydrogen producing unit. This enables even better integration, since there is no need for a separate or dedicated compressor for recycling hydrogen within the hydrogen producing unit for e.g. hydrogenation of sulfur in the cleaning unit.

In an embodiment, said water gas shift unit comprises: at least one, and preferably a series of high-temperature shift units, optionally also at least one low-temperature shift unit arranged downstream said at least one high-temperature shift unit; or said gas shift unit is a single medium-temperature shift unit; the hydrogen purification unit comprises a pressure-swing absorption (PSA) unit, a cryogenic unit, or a hydrogen membrane separation unit, or a combination thereof, preferably a PSA unit; the CO₂-removal unit is selected from an amine wash unit, a CO₂ membrane separation unit, or a cryogenic separation unit, preferably an amine wash unit.

These technologies are also well-known in the art.

In an embodiment, the process comprises providing in said HPU: a single prereforming unit, preferably a single adiabatic pre-reforming unit; a single e-SMR; and a single medium-temperature shift unit; thereby further maintaining the HPU as compact as possible.

In an embodiment, the carbon intensity of the HPU is less than 1 kg CO₂e/kg H₂.

The carbon intensity of the HPU and thereby also of the process and plant for producing hydrocarbons, particularly where the feedstock to the process is from renewable origin, thus carbon neutral, is also much lower than state of the art plants.

Carbon intensity (CI) is one of the key performance indicators (KPI) that organizations are focusing on to determine their environmental. The CI score is a life cycle measurement of all total hydrocarbons, or greenhouse gas emitted, versus e.g. the amount of energy consumed. The CI is typically used in United States of America and other countries in the Greenhouse Gases, Regulated Emissions and Energy Use in Transportation (GREET) Model and is calculated by compiling all the carbon emitted along the supply chain for that fuel including all the carbon used to (where applicable) explore, mine, collect, produce, transport, distribute, dispense and burn the fuel, however there are other calculation modes for the CI. Lower CI values are most favorable because they are the cleanest solutions.

In an embodiment, in step iv) the entire off-gas stream is passed as second recycle gas stream to the hydrogen producing unit (HPU).

In an embodiment, prior to conducting step iv), said off-gas stream, i.e. said second recycle gas stream, passes to a separation stage, the separation stage preferably being at least one of an amine absorption stage, a caustic scrubber, and a sulfur absorbent, for removing H₂S and thereby producing said second recycle gas stream.

It would be understood that this separation stage for removing H₂S from the off-gas, is different than the separation stage for the treatment of the main hydrotreated stream (step ii).

The obtained second recycle gas stream entering the hydrogen producing unit contains therefore light hydrocarbons such as C₁-C₄ hydrocarbons, H₂, NH₃, CO and CO₂, yet no H₂S or only minor amounts of H₂S. The off-gas stream and second recycle stream derived thereof contains hydrogen not consumed from the hydrotreating unit(s) of the hydroprocessing stage as soluble hydrogen in hydrocarbon phase, and is advantageously used as the feed in the hydrogen producing unit.

In an embodiment, the first recycle gas stream is not subjected to a separation stage for removing H₂S and/or CO₂, optionally also for removing NH₃ and/or CO, prior to being passed to the hydroprocessing stage, i.e. the first recycle gas stream is sent directly to the hydroprocessing stage, suitably to a first catalytic hydrotreating unit of the hydroprocessing stage.

The term “sent directly” means that there are not intermediate steps or units changing the composition of the stream.

The first recycle stream and correspondingly said hydrogen-rich stream of step ii) and suitably comprises 50% vol. H₂ or more, light hydrocarbons, H₂S, CO and CO₂. This first recycle gas stream is significantly larger i.e. significantly larger flow rate, than the off-gas stream, thus there is no separation stage such as an amine scrubber in the first recycle stream for removing H₂S and/or CO₂, often for removing H₂S and CO₂, prior to the stream being passed to the hydroprocessing stage. A separation stage such as an amine scrubber is provided in the much smaller off-gas stream and targeted for H₂S removal. Furthermore, the H₂S of the first recycle gas provides a sulfur source for keeping the hydrotreating catalyst e.g. hydrodeoxygenation catalyst of the hydroprocessing stage in sulfided form. There is no need to externally source the sulfur, particularly as renewable feedstocks often lack sulfur.

In an embodiment, in step i) the hydroprocessing stage comprises:
i-1) passing the feedstock through a first catalytic hydrotreating unit under the addition of hydrogen for producing a first hydrotreated stream;
i-2) passing the first hydrotreated stream to a dewaxing section comprising a second catalytic hydrotreating unit under the addition of hydrogen for producing said main hydrotreated stream;
optionally, between step i-1) and i-2) the process further comprises passing the first hydrotreated stream to a separator, such as a high-pressure or low-pressure separator, for removing H₂S, NH₃, and H₂O, thereby producing said first hydrotreated stream, and optionally also producing a vapor stream, and a recycle oil stream;
and in step ii) the separation stage comprises:
ii-1) passing the main hydrotreated stream to a separator, preferably a cold separator, for producing said aqueous stream, said hydrogen-rich stream, and a heavy hydrocarbon stream;
ii-2) passing the heavy hydrocarbon stream to a fractionation section for producing said off-gas stream, and said hydrocarbon product.

Optionally, the process comprises using one or more additional catalytic hydrotreating units under the addition of hydrogen, such as third catalytic hydrotreating unit or a cracking section. For instance, it would be understood that when a hydrocarbon product boiling in the jet fuel range is desired, a hydrocracking unit is suitably used, for instance prior to passing the thus resulting first hydrotreated stream to the dewaxing section.

Yet again, the provision of hydrogen in the hydroprocessing stage, in particular step i-1), i-2) and optionally also in the step in between, i.e. passing the first hydrotreated stream to a separator for removing H₂S and NH₃, is mainly from said make-up hydrogen stream and said first recycle stream. The present invention provides a high level of integration, hence there is no need to resort to the use of external make-up hydrogen, i.e. make-up hydrogen supplied from outside the process and plant of the present invention. As used herein, the term “mainly” means also exclusively, i.e. the provision of hydrogen in hydrogen in the hydroprocessing stage is from said make-up hydrogen stream and said first recycle stream.

In an embodiment, the feedstock is obtained from a raw material of renewable origin, such as originating from plants, algae, animals, fish, vegetable oil refining, domestic waste, waste rich in plastic, industrial organic waste like tall oil or black liquor, or a feedstock derived from one or more oxygenates taken from the group consisting of: triglycerides, fatty acids, resin acids, ketones, aldehydes and alcohols, where said oxygenates originate from one or more of a biological source, a gasification process, a thermal decomposition process such as a pyrolysis process or hydrothermal liquefaction process or thermal liquefaction, Fischer-Tropsch synthesis, or methanol based synthesis.

Where the feedstock is from a renewable origin, it may be regarded as carbon neutral. This, compounded with the carbon removal and optional capture in the HPU, the provision of e-SMR in the HPU and the associated reduction of hydrocarbon fuel consumption in a fired heater of e.g. the hydroprocessing stage, enables a process and plant for producing hydrocarbons with a much lower carbon intensity (CI) than prior art approaches, in particular negative carbon intensity. For instance, the CI is-1 kg CO₂e/kg hydrocarbon product; the hydrocarbon product being any of said naphtha, jet fuel such as SAF, diesel, and combinations thereof.

The hydrocarbon products, i.e. products produced according to the process and plant of the invention represent so-called green products or renewable products, thus the diesel product may be regarded as renewable diesel, the jet fuel as renewable jet fuel, such as sustainable aviation fuel (SAF) and the naphtha as renewable naphtha.

In an embodiment, the first catalytic hydrotreating unit is hydrodeoxygenation (HDO) i.e. HDO is conducted in a HDO unit, the second catalytic hydrotreating is hydrodewaxing (HDW), and an additional catalytic hydrotreating such as a third catalytic hydrotreating is hydrocracking (HCR).

The material catalytically active in hydrotreating, here HDO, typically comprises an active metal (sulfided base metals such as nickel, cobalt, tungsten and/or molybdenum, but possibly also either elemental noble metals such as platinum and/or palladium) and a refractory support (such as alumina, silica or titania, or combinations thereof).

Hydrotreating conditions, here HDO, involve a temperature in the interval 250-400° C., a pressure in the interval 30-150 bar, and a liquid hourly space velocity (LHSV) in the interval 0.1-2, optionally together with intermediate cooling by quenching with cold hydrogen, feed or product

The material catalytically active in hydrodewaxing (HDW), herein used interchangeably with the term hydroisomerisation (HDI) or simply isomerization, typically comprises an active metal (either elemental noble metals such as platinum and/or palladium or sulfided base metals such as nickel, cobalt, tungsten and/or molybdenum), an acidic support (typically a molecular sieve showing high shape selectivity, and having a topology such as MOR, FER, MRE, MWW, AEL, TON and MTT) and a refractory support (such as alumina, silica or titania, or combinations thereof).

Isomerization conditions (HDI) involve a temperature in the interval 250-400° C., a pressure in the interval 20-100 bar, and a liquid hourly space velocity (LHSV) in the interval 0.5-8.

The material catalytically active in hydrocracking is of similar nature to the material catalytically active in isomerization, and it typically comprises an active metal (either elemental noble metals such as platinum and/or palladium or sulfided base metals such as nickel, cobalt, tungsten and/or molybdenum), an acidic support (typically a molecular sieve showing high cracking activity, and having a topology such as MFI, BEA and FAU) and a refractory support (such as alumina, silica or titania, or combinations thereof). The difference to material catalytically active isomerization is typically the nature of the acidic support, which may be of a different structure (even amorphous silica-alumina) or have a different acidity e.g. due to silica: alumina ratio.

Hydrocracking conditions involve a temperature in the interval 250-400° C., a pressure in the interval 30-150 bar, and a liquid hourly space velocity (LHSV) in the interval 0.5-8, optionally together with intermediate cooling by quenching with cold hydrogen, feed or product

Other types of hydrotreating are also envisaged, for instance hydrodearomatization (HDA). The material catalytically active in hydrodearomatization typically comprises an active metal (typically elemental noble metals such as platinum and/or palladium but possibly also sulfided base metals such as nickel, cobalt, tungsten and/or molybdenum) and a refractory support (such as amorphous silica-alumina, alumina, silica or titania, or combinations thereof).

Hydrodearomatization conditions involve a temperature in the interval 200-350° C., a pressure in the interval 20-100 bar, and a liquid hourly space velocity (LHSV) in the interval 0.5-8.

In a second aspect of the invention, there is also provided a plant for carrying out the process according to any of the above embodiments; the plant comprising:
a hydroprocessing stage arranged to receive a feedstock originating from a renewable source and a hydrogen-rich feed stream, such as a hydrogen-rich feed stream, for producing a main hydrotreated stream;
a separation stage arranged to receive said main hydrotreated stream for producing an aqueous stream, a hydrogen-rich stream as a first recycle gas stream, an off-gas stream comprising hydrocarbons as a second recycle stream, and said hydrocarbon product, boiling at above 50° C.;
a hydrogen producing unit (HPU) arranged to receive said second recycle gas stream optionally together with one or more of said hydrocarbon product, preferably naphtha, for producing a make-up hydrogen stream;
   said HPU comprising:
a steam reforming unit arranged to receive said second recycle gas stream and provide a synthesis gas; in which said steam reforming unit is an electrically heated steam methane reformer (e-SMR);
a pre-reforming unit arranged upstream said e-SMR;
a water gas shift unit arranged to receive said synthesis gas and provide a shifted synthesis gas;
   said HPU further comprising:
a) a CO₂-separation unit arranged to receive said shifted synthesis gas and provide a CO₂-rich gas stream and a CO₂-depleted synthesis gas stream; and a hydrogen purification unit arranged to receive said CO₂-depleted synthesis gas stream and provide said make-up hydrogen stream and a waste off-gas stream; or
b) a hydrogen purification unit arranged to receive said shifted synthesis gas and provide said make-up hydrogen stream and a waste off-gas stream; and a CO₂-separation unit arranged to receive said waste off-gas stream and provide a CO₂-rich gas stream and a CO₂-depleted waste off-gas stream;
said plant further comprising:
   a catalytic hydrotreating unit in said hydroprocessing stage, a separation unit i.e. a fractionation section in said separation stage, and optionally an auxiliary steam boiler for steam production;
   a conduit for passing at least a portion of said make-up hydrogen gas to said hydroprocessing stage;
   a conduit for passing said waste off-gas stream or said CO₂-depleted waste of gas stream to: a point between the pre-reforming unit and the e-SMR; and to a fired heater in any of said catalytic hydrotreating unit of the hydroprocessing stage, i.e. to a fired heater of any of the catalytic hydrotreating units of the hydroprocessing stage, the separation unit i.e. the fractionation section of the separation stage, optionally the auxiliary steam boiler for steam production, and combinations thereof.

In an embodiment, said conduit for passing said waste off-gas stream or said CO₂-depleted waste of gas stream, is arranged for directly passing said waste off-gas stream or said CO₂-depleted waste of gas stream to: a point between the pre-reforming unit and the e-SMR.

As in connection with the first aspect of the invention, the term “directly passing” means without passing through an intermediate unit changing the composition of the stream.

It will be understood that the term “separation unit” and “fractionation section” are used interchangeably.

In an embodiment, the plant further comprises:
a separation stage, which is preferably at least one of an amine absorption stage, a caustic scrubber, and a sulfur absorbent, arranged to receive said off-gas stream, for removing H₂S.

In an embodiment, the plant further comprises:
a compressor section arranged to receive said first recycle gas stream and at least a portion of the make-up hydrogen stream produced in said HPU, for generating said hydrogen-rich feed stream and a make-up hydrogen recycle stream;
a conduit for passing said first recycle gas stream to said compressor section;
a conduit for passing said make-up hydrogen stream from the HPU to said compressor section;
optionally a conduit for recycling said make-up hydrogen recycle stream to the HPU.

Any of the embodiments and associated benefits according to the first aspect (process) of the invention may be used together with the second aspect (plant) of the invention, or vice versa.

### LEGENDS TO THE FIGURES

The sole appended FIGURE (Fig.) shows a schematic flow diagram of the overall process and plant according to a specific embodiment of the invention.

### DETAILED DESCRIPTION

With reference to the FIGURE, a block flow diagram of the overall process/plant 100 is shown, where renewable feed 12 is fed to the hydroprocessing stage 110. This stage or section comprises a feed section and reactor section including HDO, HDW and optionally also HCR (hydrocracking) units, for producing a main hydrotreated stream 14, which is then passed to separation stage 120 which produces: aqueous (water) stream 16; hydrogen-rich stream 18 as a first recycle stream; off-gas stream 20 as a second recycle stream, as well as renewable hydrocarbon products naphtha 26, jet fuel suitably as sustainable aviation fuel (SAF) 24 and diesel 22. Maritime fuel as a heavy fraction (not shown) may also be produced. The off-gas stream 20 passes to an optional H₂S removal stage 130 to form a treated off-gas stream-second recycle stream 32—which is then used as feed for the hydrogen producing unit 140, optionally together with produced renewable hydrocarbon product, e.g. naphtha 26. The first recycle stream 18 being sent to hydroprocessing stage 110 does not include the use of a separation section for removing H₂S and/or carbon oxides (CO, CO₂), i.e. stream 18 is sent directly to the hydroprocessing stage 110, via a compressor (not shown) in compressor section 150. The hydrogen producing unit (HPU) 140 comprises a first section 142 which may include a cleaning unit such as sulfur-chlorine-metal absorption or catalytic unit such as a hydrogenating unit upstream a sulfur absorption unit, a pre-reforming unit i.e. one or more pre-reforming units arranged upstream an electrically heated steam methane reformer (e-SMR), water gas shifting unit(s), and a CO₂-removal unit. These units are not shown in said first section 142 of the HPU 140. The CO₂-removal unit removes, i.e. captures, the CO₂ from shifted synthesis gas and exits as CO₂-rich gas stream 34, while providing a CO₂-depleted synthesis gas stream 30. A hydrogen purification unit, such as PSA unit 144, is provided as a second section of the HPU 140 to further enrich in hydrogen the CO₂-depleted synthesis gas stream 30 thereby producing a make-up hydrogen stream 36, as well as a waste off-gas stream 38, e.g. PSA waste off-gas. As the steam reforming unit is an e-SMR, there is no flue gas therefrom emitting carbon dioxide. The waste off-gas 38, as shown by the arrow, is advantageously supplied as hydrocarbon feed to a point between the pre-reforming unit and the e-SMR (not shown) in first section 142 of HPU 140. Preferably, the waste off-gas 38 is directly supplied, i.e. without passing through an intermediate unit changing its composition, as hydrocarbon feed to a point between the pre-reforming unit and the e-SMR (not shown) in first section 142 of HPU 140. Further, waste off-gas 38 is advantageously supplied as fuel in e.g. the hydroprocessing stage 110, in particular as fuel to a fired heater (not shown) in any of: a catalytic hydrotreating unit of the hydroprocessing stage, a separation unit of the separation stage, this separation unit being a fractionation section, optionally an auxiliary steam boiler for steam production, and combinations thereof. The first recycle gas stream 18 passes to optional compressor section 150 which includes a recycle compressor and make-up gas compressor, not shown. The first recycle gas stream 18 and make-up hydrogen stream 36 are then compressed by respectively the recycle compressor and the make-up compressor and used for adding hydrogen as stream 40 into the hydroprocessing stage 110. From the make-up compressor, a hydrogen stream 42 may also be recycled to hydrogen producing unit 140, 142.

1. A process for producing a hydrocarbon product, said process comprising the steps of:
i) passing a feedstock originating from a renewable source through a hydroprocessing stage for producing a main hydrotreated stream;
ii) passing the main hydrotreated stream to a separation stage for producing:
an aqueous stream,
a hydrogen-rich stream as a first recycle gas stream,
an off-gas stream comprising hydrocarbons,
and said hydrocarbon product, boiling at above 50° C.;
iii) passing the first recycle gas stream to the hydroprocessing stage;
iv) passing the off-gas stream as a second recycle gas stream to a hydrogen producing unit (HPU) for producing a hydrogen stream as a make-up hydrogen stream;
v) passing at least a portion of the make-up hydrogen stream to the hydroprocessing stage;
wherein said HPU comprises subjecting said second recycle gas stream to: catalytic steam reforming in a steam reforming unit for providing a synthesis gas; water gas shift conversion of said synthesis gas in a water gas shift unit for providing a shifted synthesis gas; carbon dioxide removal of at least a portion of said shifted synthesis gas in a CO₂-separation unit thereby providing a CO₂-rich gas stream and a CO₂-depleted synthesis gas stream; and
hydrogen purification of at least a portion of said CO₂-depleted synthesis gas stream in a hydrogen purification unit; wherein the steam reforming unit is an electrically heated steam methane reformer (e-SMR) together with a pre-reforming unit arranged upstream said e-SMR; wherein said hydrogen purification unit produces said make-up hydrogen stream and a waste off-gas stream; and wherein at least a portion of said waste off-gas stream is supplied as a hydrocarbon feed to a point between the pre-reforming unit and the e-SMR;
and as fuel to a fired heater in any of: a catalytic hydrotreating unit of the hydroprocessing stage, a separation unit of the separation stage, optionally an auxiliary steam boiler for steam production, and combinations thereof.

2. A process for producing a hydrocarbon product, said process comprising the steps of:
i) passing a feedstock originating from a renewable source through a hydroprocessing stage for producing a main hydrotreated stream;
ii) passing the main hydrotreated stream to a separation stage for producing:
an aqueous stream,
a hydrogen-rich stream as a first recycle gas stream,
an off-gas stream comprising hydrocarbons,
and said hydrocarbon product, boiling at above 50° C.;
iii) passing the first recycle gas stream to the hydroprocessing stage;
iv) passing the off-gas stream as a second recycle gas stream to a hydrogen producing unit (HPU) for producing a hydrogen stream as a make-up hydrogen stream;
v) passing at least a portion of the make-up hydrogen stream to the hydroprocessing stage;
wherein said HPU comprises subjecting said second recycle gas stream to: catalytic steam reforming in a steam reforming unit for providing a synthesis gas; water gas shift conversion of said synthesis gas in a water gas shift unit for providing a shifted synthesis gas; hydrogen purification of at least a portion of said shifted synthesis gas in a hydrogen purification unit;
wherein the steam reforming unit is an electrically heated steam methane reformer (e-SMR) together with a pre-reforming unit arranged upstream said e-SMR; wherein said hydrogen purification unit produces said make-up hydrogen stream and a waste off-gas stream; wherein at least a portion of said waste off-gas stream is subjected to carbon dioxide removal in a CO₂-separation unit thereby providing a CO₂-rich gas stream and a CO₂-depleted waste off-gas stream; and wherein at least a portion of said CO₂-depleted waste off-gas stream and/or at least a portion of said waste off-gas stream is supplied as a hydrocarbon feed to a point between the pre-reforming unit and the e-SMR; and as fuel to a fired heater in any of: a catalytic hydrotreating unit of the hydroprocessing stage, a separation unit of the separation stage, optionally an auxiliary steam boiler for steam production, and combinations thereof.

3. Process according to claim 1, wherein said at least a portion of said waste off-gas stream, is directly supplied as the hydrocarbon feed to a point between the pre-reforming unit and the e-SMR.

4. Process according to claim 2, wherein said at least a portion of said CO₂-depleted waste off-gas stream and/or at least a portion of said waste off-gas stream, is directly supplied as the hydrocarbon feed to a point between the pre-reforming unit and the e-SMR.

5. Process according to claim 1, wherein the process further comprises: carbon capture and storage (CCS), or carbon capture and utilization (CCU), of said CO₂-rich gas stream.

6. Process according to claim 1, wherein the process further comprises:
prior to said catalytic steam reforming, subjecting said second recycle stream to cleaning in a cleaning unit.

7. Process according to claim 1, wherein:
said water gas shift unit comprises:
at least one high-temperature shift units;
or
said water gas shift unit is a single medium-temperature shift unit;
the hydrogen purification unit comprises a pressure-swing absorption (PSA) unit, a cryogenic unit, or a hydrogen membrane separation unit, or a combination thereof,
and
the CO₂-removal unit is selected from: an amine wash unit, a CO₂ membrane separation unit, and a cryogenic separation unit.

8. Process according to claim 1, wherein the process comprises providing in said HPU: a single pre-reforming unit; a single e-SMR; and a single medium-temperature shift unit.

9. Process according to claim 1, wherein prior to conducting step iv), said off-gas stream passes to an off-gas separation stage for removing H₂S and thereby producing said second recycle gas stream.

10. Process according to claim 1, wherein the first recycle gas stream is not subjected to a separation stage for removing H₂S, CO₂, NH₃ and/or CO, prior to being passed to the hydroprocessing stage, i.e. the first recycle gas stream is sent directly to the hydroprocessing stage.

11. Process according to claim 1,
wherein in step i) the hydroprocessing stage comprises:
i-1) passing the feedstock through a first catalytic hydrotreating unit under the addition of hydrogen for producing a first hydrotreated stream;
i-2) passing the first hydrotreated stream to a dewaxing section comprising a second catalytic hydrotreating unit under the addition of hydrogen for producing said main hydrotreated stream;
and wherein in step ii) the separation stage comprises:
ii-1) passing the main hydrotreated stream to a first separator for producing said aqueous stream, said hydrogen-rich stream, and a heavy hydrocarbon stream;
ii-2) passing the heavy hydrocarbon stream to a fractionation section for producing said offgas stream, and said hydrocarbon product.

12. Process according to claim 1, wherein the feedstock is obtained from a raw material of renewable origin, or a feedstock derived from one or more oxygenates taken from the group consisting of: triglycerides, fatty acids, resin acids, ketones, aldehydes and alcohols, where said oxygenates originate from one or more of a biological source, a gasification process, a thermal decomposition process, FischerTropsch synthesis, or methanol based synthesis.

13. Plant for carrying out the process of claim 1, comprising:
a hydroprocessing stage arranged to receive a feedstock originating from a renewable source and a hydrogen-rich feed stream, for producing a main hydrotreated stream;
a separation stage arranged to receive said main hydrotreated stream for producing an aqueous stream, a hydrogen-rich stream as a first recycle gas stream, an off-gas stream comprising hydrocarbons as a second recycle stream, and said hydrocarbon product, boiling at above 50° C.;
a hydrogen producing unit (HPU) arranged to receive said second recycle gas stream for producing a make-up hydrogen stream;
said HPU comprising:
a steam reforming unit arranged to receive said second recycle gas stream and provide a synthesis gas; in which said steam reforming unit is an electrically heated steam methane reformer (e-SMR);
a pre-reforming unit arranged upstream said e-SMR;
a water gas shift unit arranged to receive said synthesis gas and provide a shifted synthesis gas;
said HPU further comprising:
a) a CO₂-separation unit arranged to receive said shifted synthesis gas and provide a CO₂-rich gas stream and a CO₂-depleted synthesis gas stream; and a hydrogen purification unit arranged to receive said CO₂-depleted synthesis gas stream and provide said make-up hydrogen stream and a waste off-gas stream; or
b) a hydrogen purification unit arranged to receive said shifted synthesis gas and provide said make-up hydrogen stream and a waste off-gas stream; and a CO₂-separation unit arranged to receive said waste off-gas stream and provide a CO₂-rich gas stream and a CO₂-depleted waste off-gas stream;
said plant further comprising:
a catalytic hydrotreating unit in said hydroprocessing stage and a separation unit i.e. a fractionation section, in said separation stage;
a conduit for passing at least a portion of said make-up hydrogen gas to said hydroprocessing stage;
a conduit for passing said waste off-gas stream or said CO₂-depleted waste of gas stream to: a point between the pre-reforming unit and the e-SMR; and to a fired heater in any of said catalytic hydrotreating unit of the hydroprocessing stage, the separation unit i.e. the fractionation section of the separation stage, and combinations thereof.

14. Process according to claim 1, comprising subjecting the second recycle gas stream together with the hydrocarbon product to: the catalytic steam reforming; the water gas shift conversion; the carbon dioxide removal; and the hydrogen purification.

15. Process according to claim 14, wherein the hydrocarbon product is naphtha.

16. Process according to claim 2, comprising subjecting the second recycle gas stream together with the hydrocarbon product to: the catalytic steam reforming; the water gas shift conversion; the carbon dioxide removal; and the hydrogen purification.

17. Process according to claim 16, wherein the hydrocarbon product is naphtha.

18. Process according to claim 6, wherein the cleaning unit is a sulfur-chlorine-metal absorption or catalytic unit.

19. Process according to claim 7, wherein:
said water gas shift unit comprises:
at least one low-temperature shift unit arranged downstream of the at least one high-temperature shift unit.

20. Process according to claim 8, wherein the single pre-reforming unit is a single adiabatic pre-reforming unit.

21. Process according to claim 9, wherein the off-gas separation stage is at least one of an amine absorption stage, a caustic scrubber, and a sulfur absorbent.

21. Process according to claim 10, wherein the first recycle gas stream is sent directly to a first catalytic hydrotreating unit of the hydroprocessing stage.

22. Process according to claim 11, wherein between step i-1) and i-2) the process further comprises passing the first hydrotreated stream to a second separator for removing H₂S, NH₃, and H₂O, thereby producing said first hydrotreated stream, and producing a vapor stream, and a recycle oil stream.

23. Process according to claim 22, wherein the second separator is a high-pressure or low-pressure separator.

24. Process according to claim 11, wherein the first separator is a cold separator.

25. Plant according to claim 13 further comprising an auxiliary steam boiler for steam production, wherein the conduit passes at least some of the waste off-gas stream to the auxiliary steam boiler for steam production.
